(19) United States
(12) Patent Application Publication
(10) Pub. No.: US 2005/0114793 A1
(43) Pub. Date: May 26, 2005

(54) Recording apparatus, reproducing apparatus, recording method, reproducing method, and recording medium thereof

(75) Inventor: Choon-Sik Jung, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/995,278

(22) Filed: Nov. 24, 2004

(30) Foreign Application Priority Data
Nov. 25, 2003 (KR) 2003-84182

(51) Int. Cl. G06F 3/00; G06F 17/24

(52) U.S. Cl. 715/839; 715/838; 715/501.1; 715/513; 715/805; 715/760

(57) ABSTRACT

A recording apparatus and/or reproducing apparatus including a thumbnail generation unit which generates a thumbnail of a user from a user representative image; a recording unit which generates link information linking image data, for which a user worked on, and a user thumbnail of the user who worked on image data, and records the link information and the user thumbnail on a recording medium.

### CROSS-REFERENCE TO RELATED APPLICATION

This application claims priority from Korean Patent Application No.2003-84182, filed on Nov. 25, 2003, the content of which is incorporated herein by reference.

### BACKGROUND OF THE INVENTION

1. Field of the Invention

The present invention relates to a recording apparatus and/or reproducing apparatus capable of recording and/or reproducing a thumbnail, and more particularly, to a recording apparatus, a reproducing apparatus, a recording method, and a reproducing method by which user information on a user who worked on contents recorded on a recording medium can be expressed by a thumbnail, and a computer readable recording medium on which a program for the methods is recorded.

2. Description of the Related Art

A thumbnail refers to ‘a thumbnail-sized picture’ and is a small image representing relatively large-sized original data in order to more quickly retrieve or manage a large amount of images or data.

On a recording medium in which the related art thumbnail is defined, N audio/video (A/V) bit streams generated by multiplexing audio data and/or video data are recorded. One bit stream refers to a program in which contents, such as a film or music video, are recorded.

The thumbnail defined by the prior art includes two types: one type is a menu thumbnail representing contents and the other type is a mark thumbnail representing a scene specified by a mark.

The menu thumbnail is typically used as a menu screen to allow a user to select a scene that the user wants to view. A representative image of a volume of information is used when a still picture represents the contents of a disc is displayed first. A representative image of a playlist is used as a still picture to indicate the playlist contents in a menu image used for selecting a playlist.

A plurality of marks can be inserted into clips and playlists. The mark thumbnail is an image indicating a mark point in order to view the contents of a mark location.

A conventional recording/reproducing apparatus and thumbnail expression method will now be explained. A recording apparatus, a reproducing apparatus, and a file directory structure that will now be explained are also discussed in U.S. Patent Application No. US2002/0135608.

FIG. 1 is a schematic block diagram of the structure of a conventional recording apparatus.

Referring to FIG. 1, the recording apparatus 10 includes a transport stream decoder 11, a PLL circuit 12, a clock counter 13, a source packetizer 14, and a recording buffer 15.

The transport stream decoder 11 receives MPEG-2 transport stream (TS) transmitted by digital broadcasting, decodes the transport stream and outputs to a display apparatus 17.

The source packetizer 14 receives a partial transport stream extracted from the transport stream, and adds a timestamp indicating the input time point of the transport stream, to the transport stream. At this time, the timestamp is generated by the clock counter 13 synchronized to 27 MHz by the PLL circuit 12.

The transport stream output by the source packetizer 14 is stored in the recording buffer 15 and then recorded on a recording medium 16.

FIG. 2 is a schematic block diagram of the structure of a conventional reproducing apparatus.

Referring to FIG. 2, the reproducing apparatus 20 includes a reading buffer 21, a source depacketizer 22, a clock counter 23, a PLL circuit 24, and a transport stream decoder 25.

The reading buffer 21 reads data from the recording medium 27 and then transfers the data to the source depacketizer 22. The source depacketizer 22 removes the timestamp attached to the stream data and then transmits the stream data to the transport stream decoder 25. At this time, in the same manner as in the recording apparatus, the source depacketizer 22 depacketizes data packets referring to timing information generated by the clock counter 23 synchronized to 27 MHz by the PLL circuit 24.

The transport stream decoder 25 decodes the received stream data and outputs the decoded stream data to the display apparatus 26.

In order to implement random access or special reproduction, editing, and the like in an optical recording medium, the program recorded by the recording apparatus described above has a directory structure as shown in FIG. 3.

FIG. 3 is a diagram showing the directory structure of a conventional digital video recording (DVR) system.

Recording unit data is a clip that includes clip AV stream data and clip information data. Clip AV stream data includes video data, audio data, and additional data. Clip information data is coupled with clip AV stream data in a 1:1 relation, and includes characteristic information used in recording the corresponding AV stream data.

Reproducing unit data includes information to reproduce clips that are recording data units, and top-level data of reproducing unit data is referred to as playlist data. Playlist data is recorded in a playlist file which includes playlist data and mark information data. This playlist data includes a plurality of play item data units, and one play item data unit is linked to one clip information data unit and defines a method to reproduce clip AV stream data.

Referring to FIG. 3, for example, a play item 32 included in a playlist file 31 in xxxxx.rpls form has reproducing information, ‘corresponding clip name A, time information: 00 min 00 sec -25 min 30 sec’, and by using this reproducing information, clip A 33 is reproduced. That is, by using characteristic information, which was used in recording AV stream data, included in the clip information data of clip A 33, clip AV stream data is reproduced.

Meanwhile, data related to a menu thumbnail or a mark thumbnail are placed in a low level of the DVR directory, in which menu.tidx is a file storing index numbers to find menu thumbnail image data, menu.tdt is a file storing actual menu thumbnail image data, mark.tidx is a file storing index numbers to find a mark thumbnail image data, and mark.tdt is a file storing actual mark thumbnail image data.

Referring to FIGS. 4 through 6, a device where information on thumbnails is recorded will now be explained.

FIG. 4 illustrates the info.dvr 40 shown in FIG. 3.

The info.dvr 40 stores DVR Volume 41, which is information on the volume, Table Of PlayList 42, which is information on an array of playlists, and the like.

DVR Volume 41 includes UIAppInfoVolume 43, which stores characteristic information of the volume, and IAppInfoVolume 43, which includes ref_thumbnail_index 45 that stores index numbers used in identifying a thumbnail indicating a volume.

TableOfPlayList 42 includes UIAppInfoPlayList 44, which stores characteristic information of playlists, and UIAppInfoPlayList 44, which includes ref_thumbnail_index 46 that stores index numbers used in identifying a representative image of a playlist.

FIG. 5 illustrates the xxxxx.rpls shown in FIG. 3.

The xxxxx.rpls 50 includes PlayListMark 51, which stores mark information attached to a playlist, and PlayListMark 51, which includes ref_thumbnail_index 52 that stores index numbers used in identifying a mark thumbnail corresponding to a mark.

FIG. 6 illustrates the zzzzz.clpi 60 shown in FIG. 3.

The zzzzz.clpi 60 includes ClipMark 61, which stores information on a mark attached to a clip, and ClipMark 61, which includes ref_thumbnail_index 62 that stores index numbers used in identifying a mark thumbnail corresponding to a clip mark.

FIG. 7 is a diagram illustrates a conventional screen on which a thumbnail is displayed.

Referring to FIG. 7, on a top area of the screen, menu thumbnails 71 for a program and playlists are displayed horizontally in the width direction, and below the top area of the screen, mark thumbnails 72 for playlists or clips are displayed vertically in the length direction. These menu thumbnails or mark thumbnails are images representing the contents, or are represented by one image of the contents.

However, in the conventional thumbnail expression, a thumbnail can be expressed only by some images of the contents or by an image representing the contents, and there is no method by which a thumbnail can be expressed by using user information or a user image. Accordingly, when a thumbnail is expressed, in addition to simply expressing a menu or mark by a thumbnail, a need exists for user information on users who generated or edited the contents to be expressed as a thumbnail.

### SUMMARY OF THE INVENTION

The invention provides a recording apparatus, a reproducing apparatus, a recording method, and/or a reproducing method by which user information on a user who recorded, edited, or made marks on contents recorded on a recording medium can be expressed by a thumbnail, and a computer readable recording medium on which a program for the apparatuses and methods is recorded.

According to an aspect of the invention, there is provided a recording apparatus including: a thumbnail generation unit which generates a user thumbnail from an input user representative image; and a recording unit which generates link information linking image data, for which a user worked on, and a user thumbnail of the user who worked on image data, and records the link information and the user thumbnail on a recording medium.

The image data worked on by the user includes at least one of image data that the user recorded, image data that the user edited, and image data on which the user made a mark.

The link information includes user thumbnail index information indicating a location on which the user thumbnail is to be recorded, and user thumbnail index reference information which is designated in recording/reproducing information on the image data for which the user worked on and is used to refer the user thumbnail index information.

The recording/reproducing information includes program information and/or playlist information and/or mark information.

The recording unit further records information on the user in reproducing information on the image data for which the user worked on.

According to another aspect of the invention, there is provided a reproducing apparatus including: a reading unit, which reads link information linking image data for which a user worked on and a user thumbnail formed with a representative image of the user who worked on the image data from a recording medium; and an output unit, which outputs the image data and the user thumbnail based on the link information.

According to still another aspect of the present invention, there is provided a recording method including: generating a user thumbnail from an input user representative image; generating link information linking image data, for which a user worked on, and a user thumbnail of the user who worked on the image data; and recording the link information and the user thumbnail on a recording medium.

According to another aspect of the invention, there is provided a reproducing method including: reading link information linking image data for which a user worked on and a user thumbnail formed with a representative image of the user who worked on the image data, from a recording medium; and outputting the image data and the user thumbnail based on the link information.

According to another aspect of the invention, there is provided a computer readable recording medium having embodied thereon a computer program for a recording method including: generating a user thumbnail from an input user representative image; generating link information linking image data; for which a user worked on, and a user thumbnail of the user who worked on image data, and recording the link information and the user thumbnail on a recording medium.

According to another aspect of the invention, there is provided a computer readable recording medium having embodied thereon a computer program for a reproducing method including: reading link information linking image data for which a user worked on and a user thumbnail formed with a representative image of the user who worked on the image data, from a recording medium; and outputting the image data and the user thumbnail based on the link information.

Additional aspects and/or advantages of the invention will be set forth in part in the description which follows and, in part, will be obvious from the description, or may be learned by practice of the invention.

### BRIEF DESCRIPTION OF THE DRAWINGS

The above objects and/or advantages of the present invention will become more apparent by describing in detail exemplary embodiments thereof with reference to the attached drawings in which:

FIG. 1 is a schematic block diagram of the structure of a recording apparatus according to the related art;

FIG. 2 is a schematic block diagram of the structure of a reproducing apparatus according to the related art;

FIG. 3 is a diagram showing the directory structure of a DVR system according to the related art;

FIG. 4 is a reference diagram illustrating the info.dvr shown in FIG. 3;

FIG. 5 is a reference diagram illustrating the xxxxx.rpls shown in FIG. 3;

FIG. 6 is a reference diagram illustrating the zzzzz.clpi shown in FIG. 3;

FIG. 7 is a diagram showing a screen on which a thumbnail is displayed according to the related art;

FIG. 8 is a schematic diagram of the structure of a recording apparatus according to an embodiment of the invention;

FIG. 9 is a schematic diagram of the structure of a reproducing apparatus according to an embodiment of the invention;

FIG. 10 is a diagram showing the directory structure of a DVR system according to an embodiment of the invention;

FIG. 11 is a reference diagram illustrating the info.dvr shown in FIG. 10;

FIG. 12 is a reference diagram illustrating the xxxxx.rpls shown in FIG. 10;

FIG. 13 is a reference diagram illustrating the zzzzz.clpi shown in FIG. 10;

FIG. 14 is a diagram showing user.tidx file and user.tdt file having information on a user representative thumbnail according to an embodiment of the invention;

FIG. 15 is a diagram showing a screen on which a user representative thumbnail is displayed according to an embodiment of the invention; and

FIG. 16 is a flowchart of a process for recording a user thumbnail on a recording medium according to the present invention.

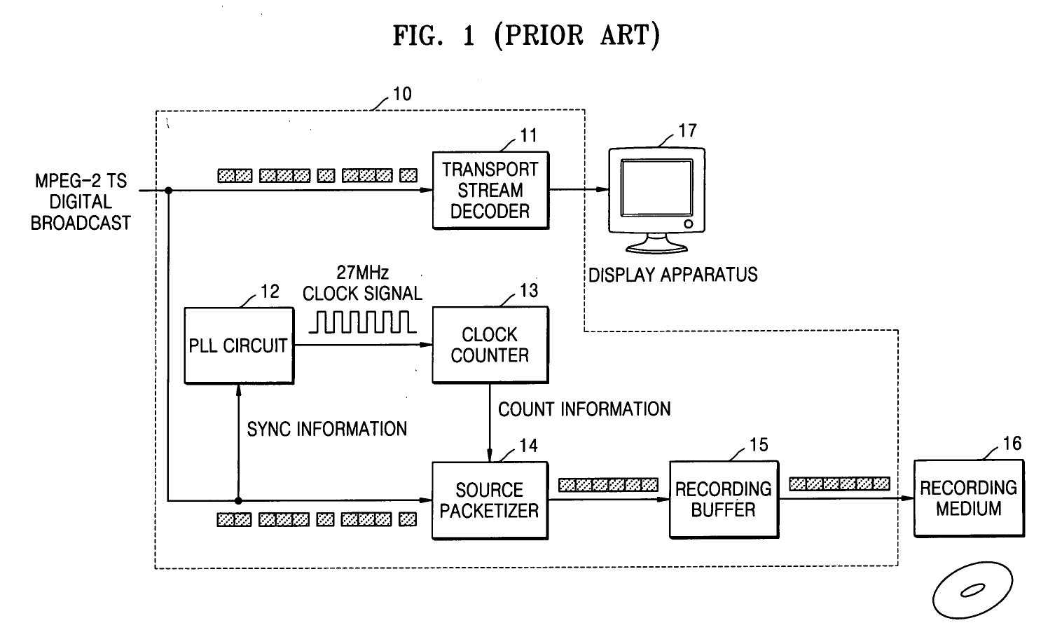

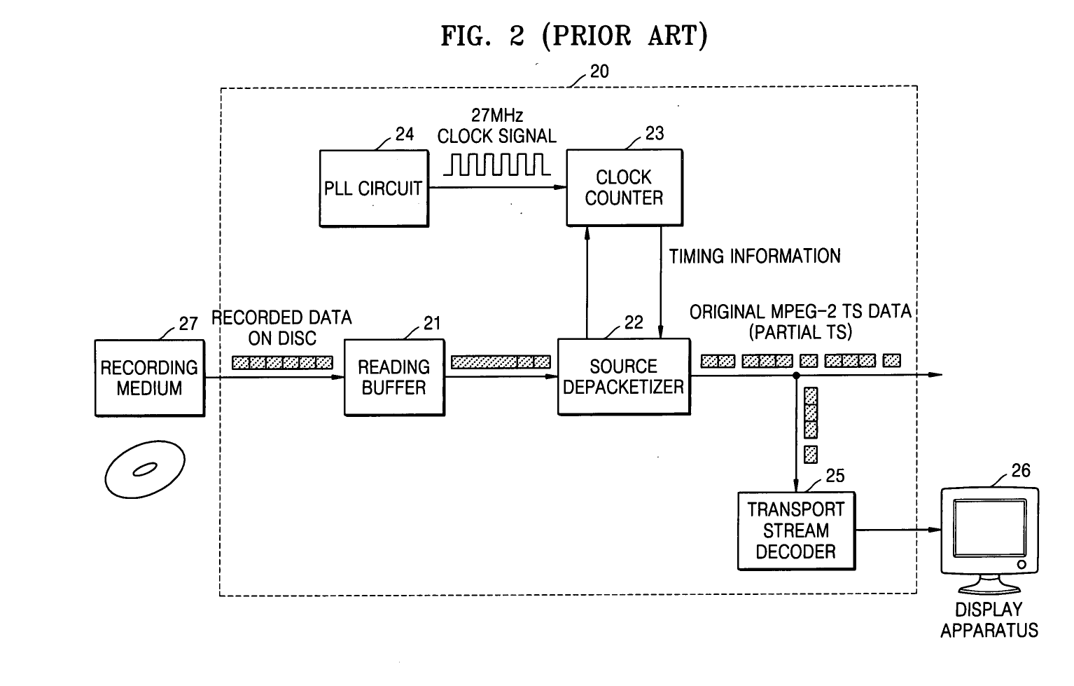

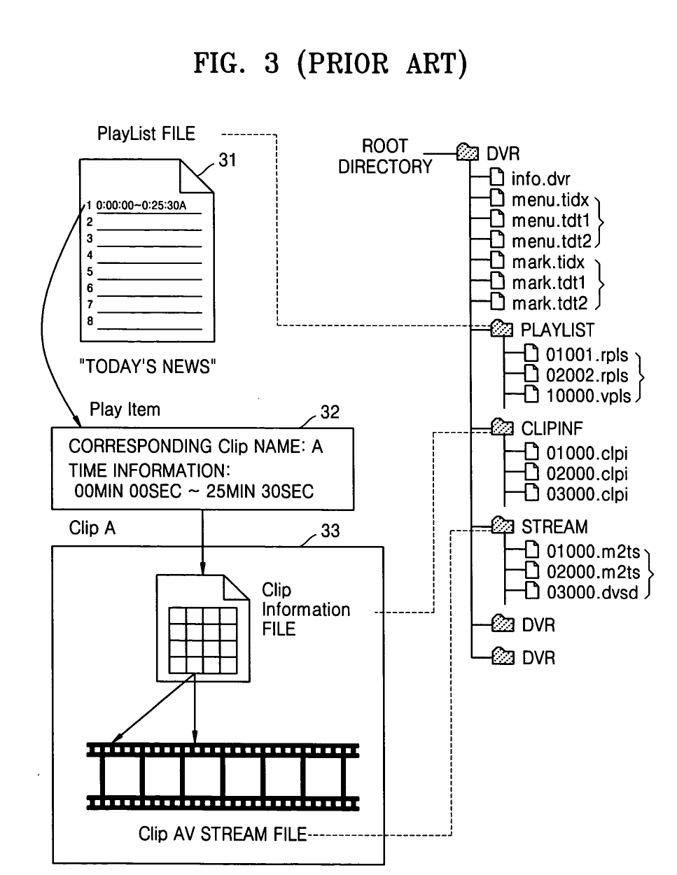

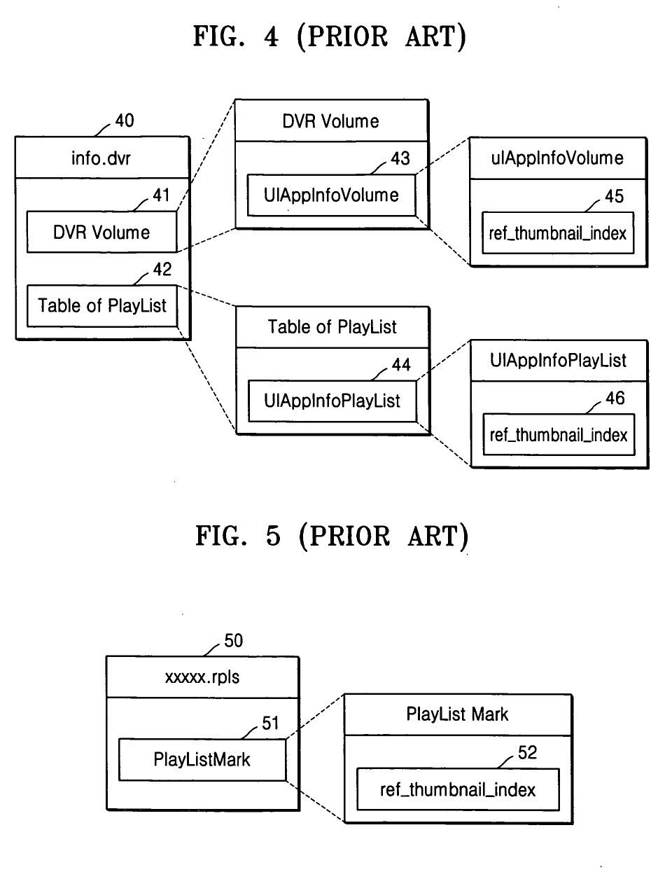

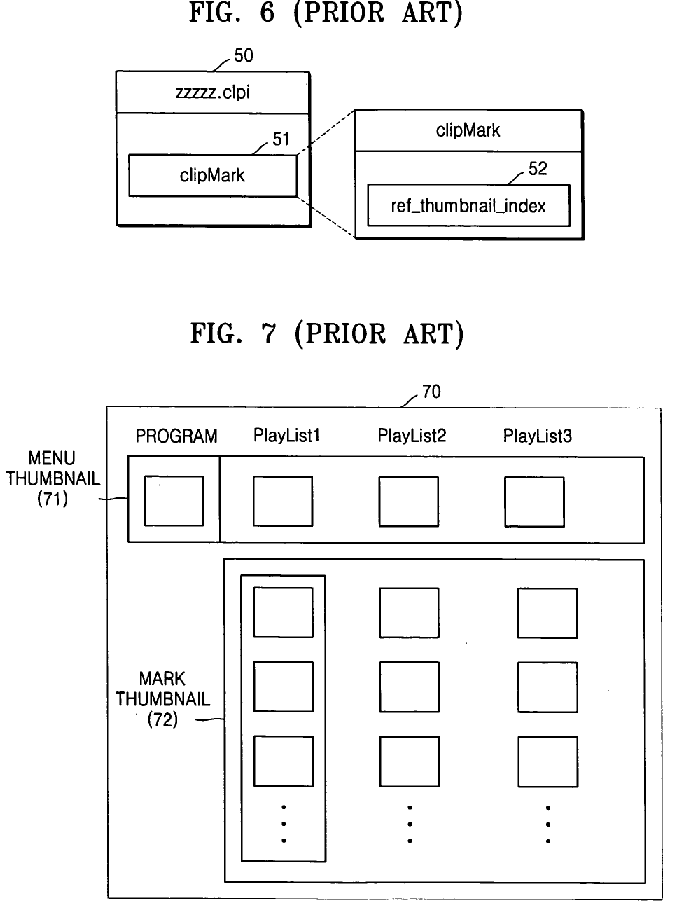

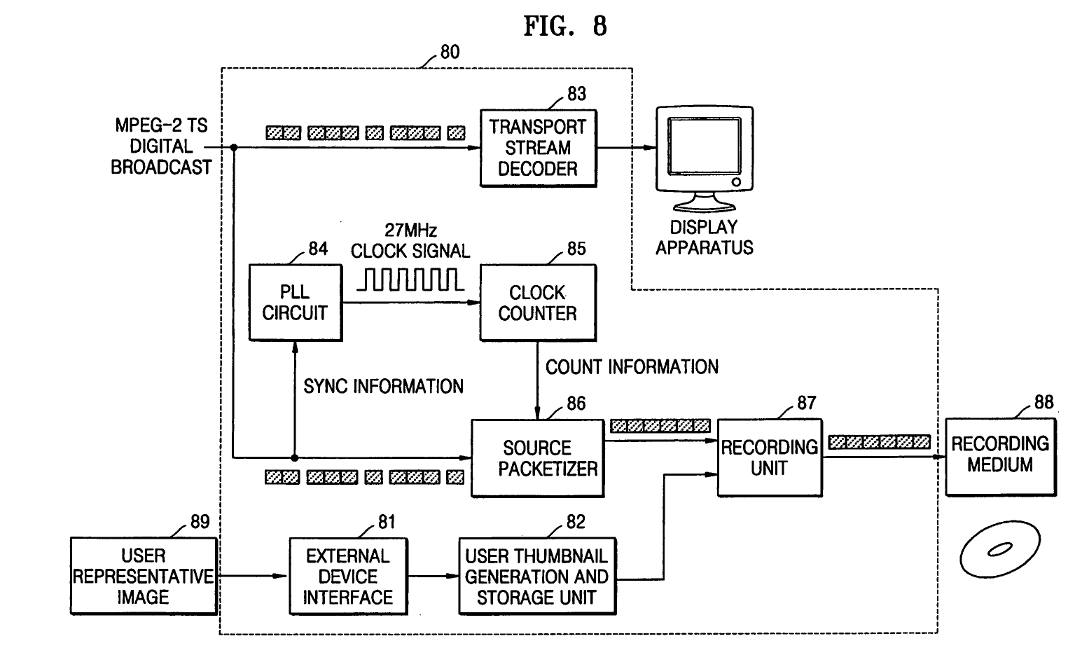

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Referring to FIG. 8, the recording apparatus 80 includes an external device interface 81, a user thumbnail generation/storage unit 82, a transport stream decoder 83, a PLL circuit 84, a clock counter 85, a source packetizer 86, and a recording unit 87.

The transport stream decoder 83 receives MPEG-2 transport stream (TS) transmitted by digital broadcasting, decodes the transport stream and outputs the decoded transport stream to a display apparatus.

The source packetizer 86 receives a partial transport stream extracted from the transport stream, and adds a timestamp indicating an input time point of the transport stream, to the transport stream. The timestamp is generated by the clock counter 85, which is synchronized to 27 MHz by the PLL circuit 84.

The transport stream output by the source packetizer 86 is stored in the recording unit 87 and then recorded on a recording medium 88.

The recording apparatus may further include the external device interface 81 and the user thumbnail generation/storage unit 82.

The external device interface 81 uses, for example, a USB port, and receives a user representative image indicating a user and transfers the user representative image to the user thumbnail generation/storage unit 82.

By adjusting the size, resolution, etc., of the user representative image data received from the external device interface 81, the user thumbnail generation/storage unit 82 generates a user thumbnail in a thumbnail format and stores the user thumbnail.

In addition, the recording unit 87 reads a user thumbnail from the user thumbnail generation/storage unit 82, generates link information linking image data for which the user performed recording, editing, or marking on the contents, and the user thumbnail, and records the link information and the user thumbnail on the recording medium. This will be explained in detail later. Of course, a control unit (not shown) may be used with the user thumbnail generation/storage unit 82 and the recording unit 87 to control performance, which is understood by a person in the field of the invention.

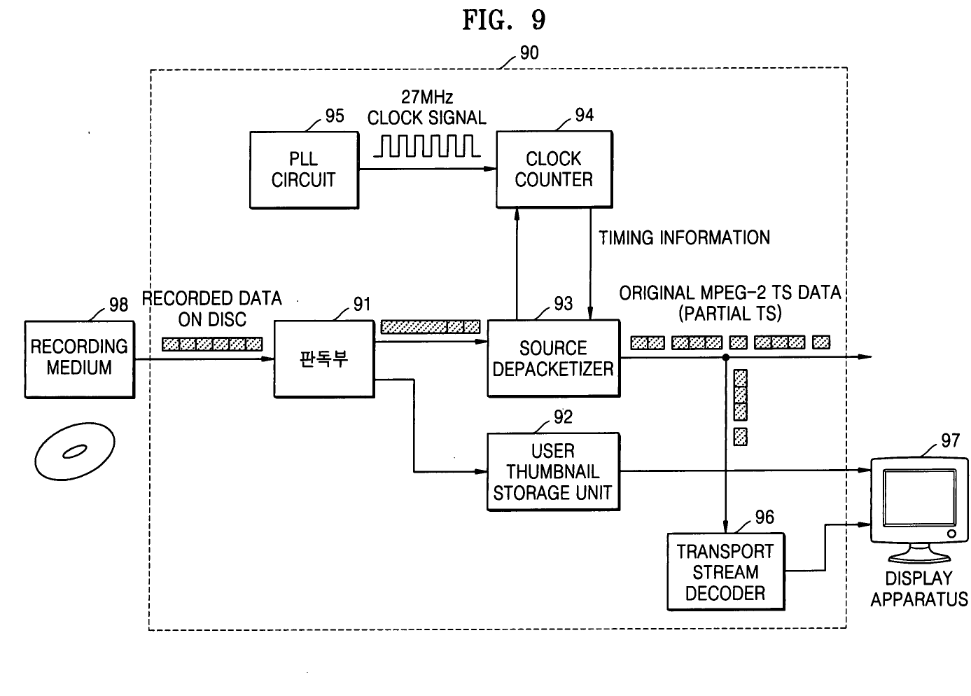

FIG. 9 is a schematic diagram of the structure of a reproducing apparatus according to a method of the invention.

Referring to FIG. 9, the reproducing apparatus 90 includes a reading unit 91, a user thumbnail storage unit 92, a source depacketizer 93, a clock counter 94, a PLL circuit 95, and a transport stream decoder 96.

The reading unit 91 reads data from the recording medium 98, and transfers the read data to the source depacketizer 93. In particular, the reading unit 91 reads link information, which links image data for which the user worked on the recording medium 98 and a user thumbnail formed with the a representative image of the user who worked on the image data, and the user thumbnail. This will be explained in detail later.

The user thumbnail storage unit 92 stores read user thumbnails and the control unit (not shown) controls based on the link information read by the reading unit 91 so that the user thumbnail stored in the user thumbnail storage unit 92 is output to the display apparatus 97.

The source depacketizer 93 removes the timestamp attached to the stream data and then transmits the stream data to the transport stream decoder 96. At this time, in the same manner as in the recording apparatus, the source depacketizer 93 depacketizes data packets referring to timing information generated by the clock counter 94, which is synchronized to 27 MHz by the PLL circuit 95.

The transport stream decoder 96 decodes the received stream data and outputs the decoded stream data to the display apparatus 97.

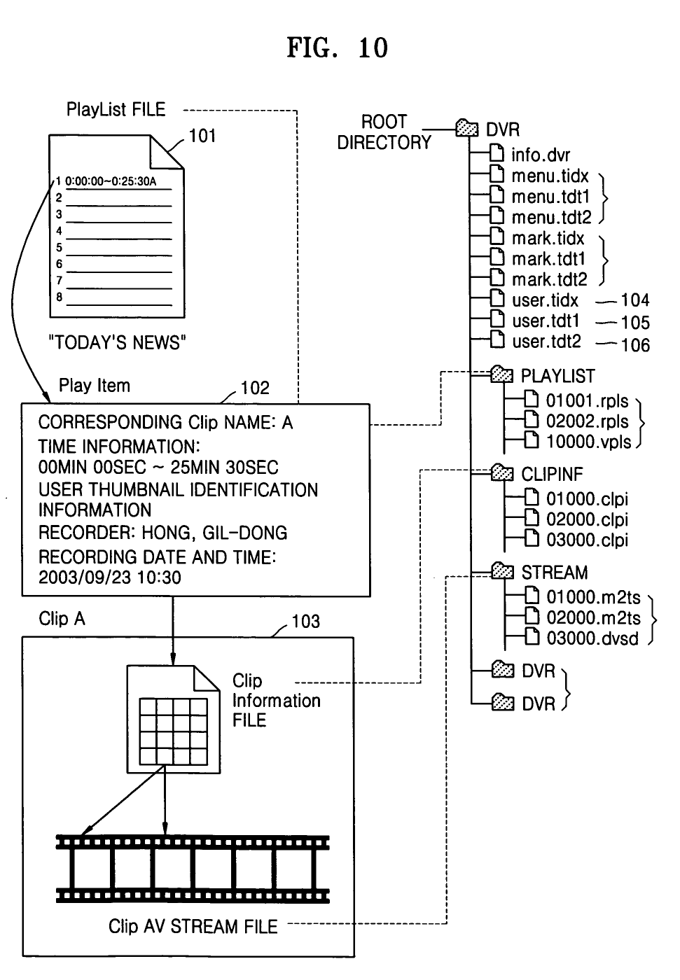

FIG. 10 is a diagram showing the directory structure of a DVR system according to the invention.

Referring to FIG. 10, in addition to menu.tidx and menu.tdt that are menu thumbnail related files, and mark.tidx and mark.tdt that are mark thumbnail related files, the structure of a system directory to which a user thumbnail is added according to the present invention further includes user.tidx 104 and user.tdt 105 and 106, which are user thumbnail related files. Identification information identifying a thumbnail indicating a user who recorded a volume and a thumbnail indicating a user who recorded a playlist can be further stored in info.dvr file. Identification information identifying a thumbnail indicating a user who made a playlist mark can be further stored in a xxxxx.rpls file and identification information identifying a thumbnail indicating a user who made a clip mark can be further stored in zzzzz.clpi file.

Referring to FIG. 10, for example, a play item 102 included in a playlist file 101 in xxxxx.rpls form has reproducing information, ‘corresponding clip name A, time information: 00 min 00 sec -25 min 30 sec, user thumbnail identification information, recorder: Hong Gil-Dong, recording date: Sep. 23, 2003 10:30’, and by using this reproducing information, clip A 103 is reproduced. That is, by using characteristic information, which was used in recording the AV stream data, that is included in the clip information data of clip A 103, clip AV stream data is reproduced. Particularly, the user thumbnail of the user who made the playlist may be reproduced together with the playlist menu thumbnail. In addition, according to another aspect of the invention, ‘Hong Gil-Dong’, the name of one user in the user information, may also be displayed.

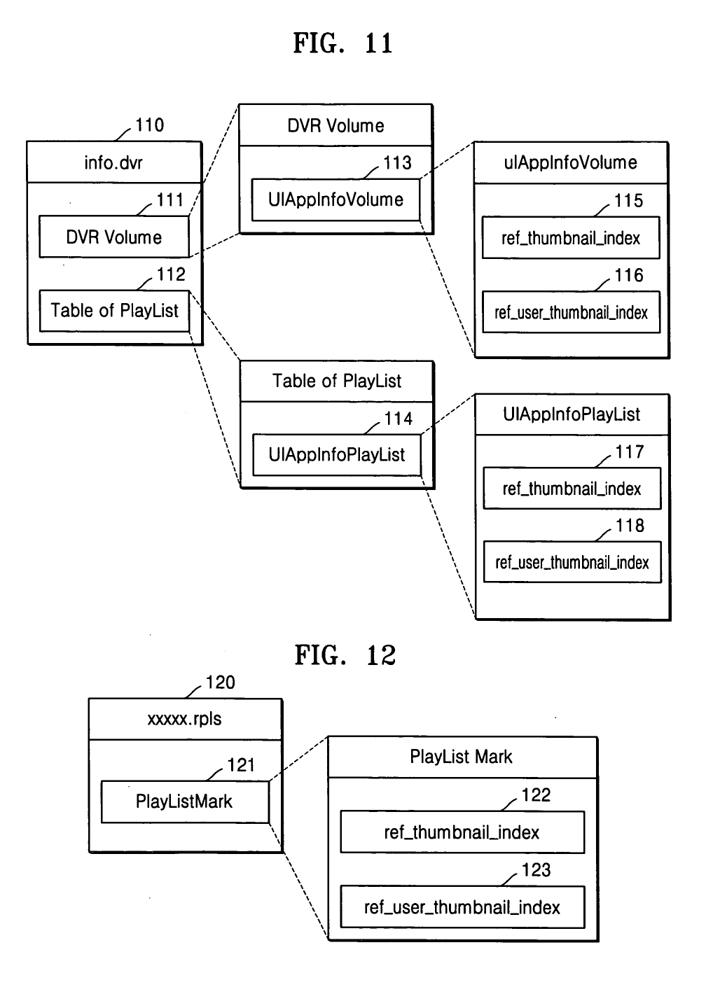

The locations in which user thumbnail identification information is recorded is explained with reference to FIGS. 11 through 13.

FIG. 11 is a diagram illustrating the info.dvr shown in FIG. 10.

The info.dvr 110 stores DVR Volume 111, which is information on the volume, TableOfPlayList 112, which is information on an array of playlists, and the like.

DVR Volume 111 includes UIAppInfoVolume 113, which stores characteristic information of the volume, IAppInfoVolume 111, which includes ref_thumbnail_index 115 that stores index numbers used in identifying a thumbnail indicating a volume, and ref_user_thumbnail_index 116, which stores index number used in identifying a user thumbnail of a user who recorded a volume according to the present invention.

Table Of PlayList 112 includes UIAppInfoPlayList 114, which stores characteristic information of playlists, UIAppInfoPlayList 114, which includes ref_thumbnail_index 117 that stores index numbers used in identifying a representative image of a playlist, and ref_user_thumbnail_index 118, which stores index numbers used in identifying a user thumbnail of a user who recorded or edited a playlist.

FIG. 12 is a diagram illustrating the xxxxx.rpls shown in FIG. 10.

The xxxxx.rpls 120 includes PlayListMark 121, which stores mark information attached to a playlist, PlayListMark 121 includes ref_thumbnail_index 122, which stores index numbers used in identifying a mark thumbnail corresponding to a mark, and ref_user_thumbnail_index 123 that stores index numbers used in identifying a user thumbnail of a user who made marks on a playlist.

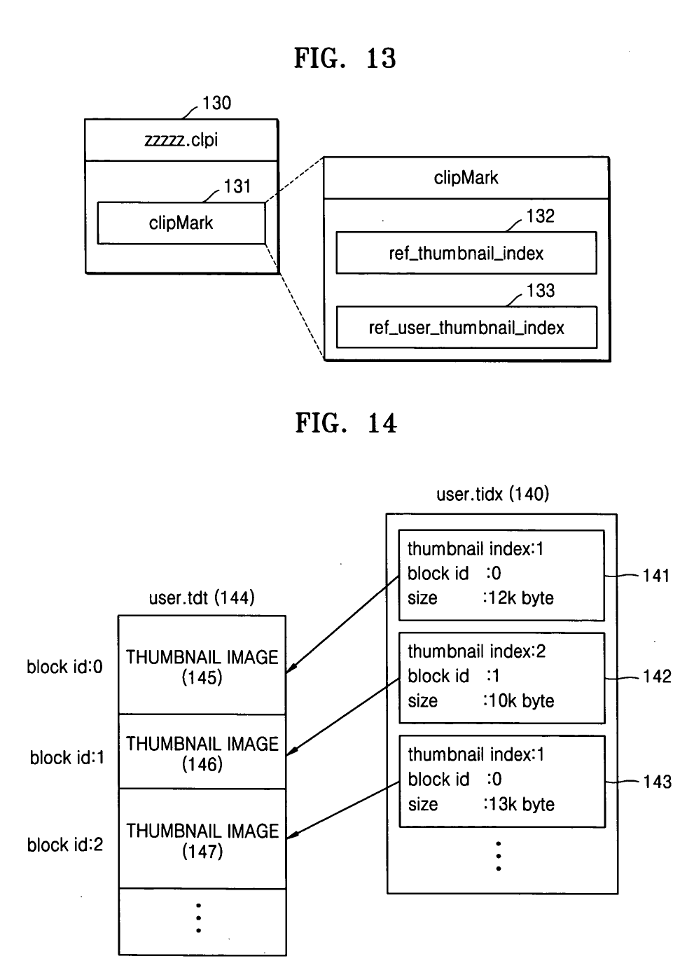

FIG. 13 is a diagram illustrating the zzzzz.clpi shown in FIG. 10.

The zzzzz.clpi 130 includes ClipMark 131, which stores information on a mark attached to a clip, ClipMark 131 includes ref_thumbnail_index 132, which stores index numbers used in identifying a mark thumbnail corresponding to a clip mark, and ref_user_thumbnail_index 133, which stores index numbers used in identifying a user thumbnail of a user who made marks on a clip.

FIG. 14 is a diagram showing the structure of user.tidx file at least and user.tdt file shown in FIG. 10 having information on a user thumbnail.

The user.tidx 140 stores index numbers used in identifying user thumbnail image data, block id that indicates the location of a thumbnail image in user.tdt file, and size information that indicates the size of a thumbnail image.

The user.tdt 144 stores each user thumbnail image according to at least block id and/or size.

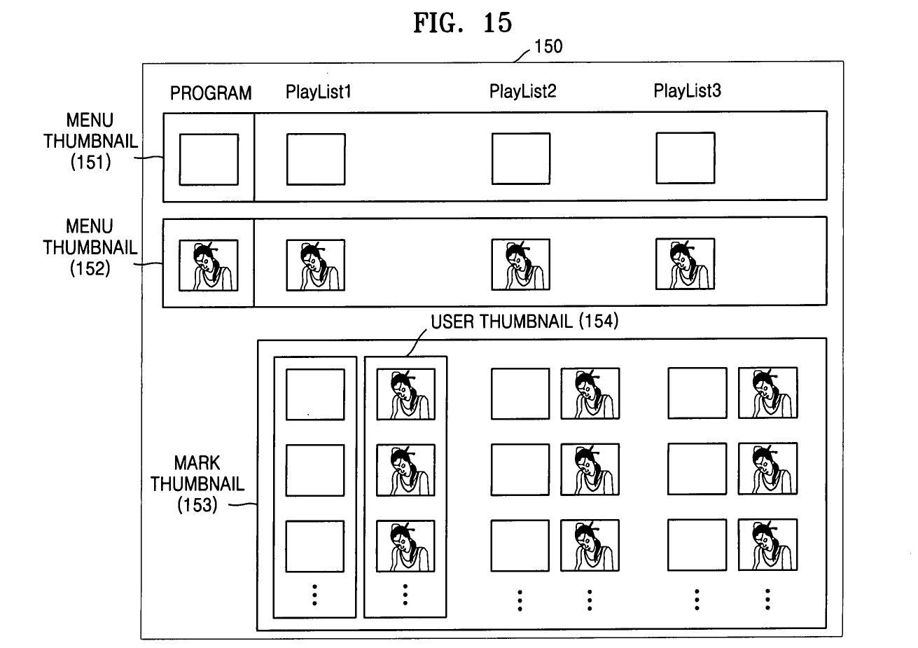

FIG. 15 is a diagram showing one layout of a screen on which a user representative thumbnail is displayed.

On top of the screen, menu thumbnails 151 for a program and playlists are displayed horizontally in the width direction, and below the menu thumbnail 151, a user thumbnail 152 is displayed. The menu thumbnail 151, playlists, and user thumbnail 152 are not limited to the above described locations and/or layout.

At the center of the screen, a mark thumbnail 153 is displayed vertically in the length direction and on the right hand side of the mark thumbnail 153, user thumbnails 154 are displayed. The mark thumbnail 153 and the user thumbnail 154 are not limited to the above described locations and/or layout.

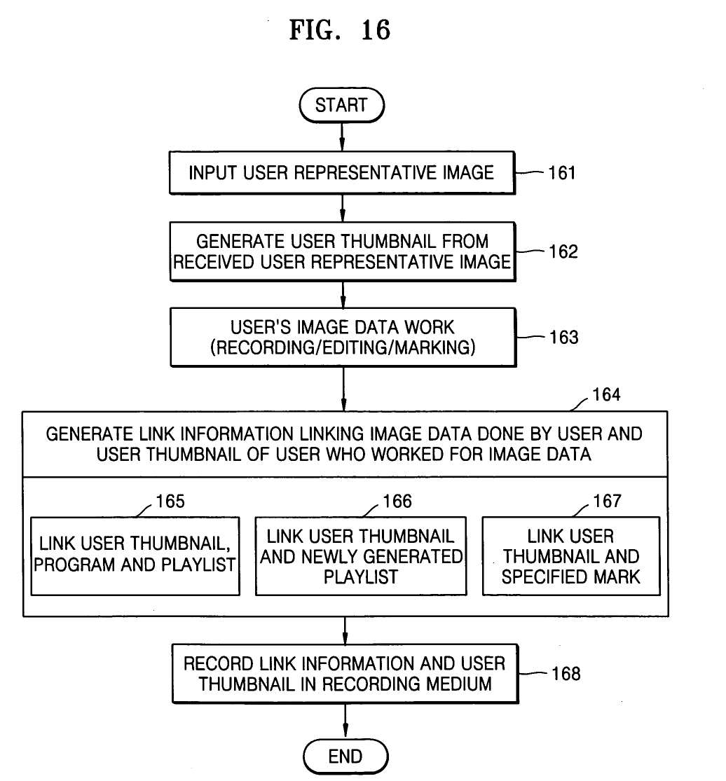

FIG. 16 is a flowchart of a process for recording a user thumbnail on a recording medium.

A user representative image to be used as a user thumbnail is input through an external device interface in operation 161.

In operation 162, the input user representative image is transferred to the thumbnail generation/storage unit, which adjusts the size, resolution, or the like of the input user representative image, and generates a user thumbnail and stores the generated user thumbnail.

In operation 163, the user performs image data work. The image data work includes recording, editing, and marking. Specifically, the user records a data stream received through digital broadcasting, or based on a program or playlist already recorded on a recording medium, and then edits the data to produce a new playlist or the like, or the user may read playlists, clips, or the like that are already recorded on a recording medium and make marks on such playlists, clips, or the like.

In operation 164, the recording unit generates link information linking image data for which the user worked on and a user thumbnail of the user who worked on the image data. That is, when the user performs a recording operation, link information linking a program or playlist to the user thumbnail can be generated in operation 165. Further, when the user performs editing, link information linking the playlist produced by the editing to the user thumbnail may be generated in operation 166. Further, when the user performs marking, link information linking the playlist mark or clip mark to the user thumbnail may be generated in operation 167.

Link information discussed herein refers to user thumbnail index information and user thumbnail index reference information. The user thumbnail index information indicates a location in which the user thumbnail is to be recorded so that the user thumbnail of the user who worked on the contents is displayed together with the contents when the contents for which the user worked on are reproduced. The user thumbnail index reference information is designated in recording/reproducing information of image data for which the user worked on, and is used to refer the user thumbnail index information. For example, the user thumbnail information may be thumbnail.index in user.tidx file described above referring to FIG. 14, and the user thumbnail index reference information may be ref_user_thumbnail_index as described above referring to FIGS. 11 through 13.

In operation 168, thus generated link information and the user thumbnail stored in the thumbnail generation/storage unit are recorded on the recording medium. The user thumbnail stored in the thumbnail generation/storage unit includes a file for storing index numbers for finding the user thumbnail image data, as well as user thumbnail image data. That is, user_tidx and user_tdt described above in FIG. 14 are included.

The invention may be embodied in a code, which can be read by at least one computer, on a computer readable recording medium. The computer readable recording medium includes all types of recording apparatuses on which computer readable data are stored. The computer readable recording media includes at least ROMs, RAMs, CD-ROMs, magnetic tapes, hard disks, floppy disks, flash memories, and optical data storage devices. Also, the code may be implemented in the form of a carrier wave (for example, transmitted over the Internet). Further, the computer readable recording media may be scattered on computer systems connected through a network and may store and execute a computer readable code in a distributed mode.

According to the invention as described above, in addition to a menu thumbnail or mark thumbnail as information for identifying the contents other types, information on a user who recorded, edited, or made marks on the contents can be easily identified.

Although a few embodiments of the present invention have been shown and described, it would be appreciated by those skilled in the art that changes may be made in these embodiments without departing from the principles and spirit of the invention, the scope of which is defined in the claims and their equivalents.

1. A recording apparatus comprising:
a thumbnail generation unit that generates a thumbnail of a user from a user representative image; and
a recording unit that generates link information to link image data and records the link information and the user thumbnail on a recording medium,
wherein the linked image data is image data that the user worked on and a user thumbnail of the user who worked on the image data.

2. The recording apparatus of claim 1, wherein the image data worked on by the user comprises:
image data that the user recorded and/or image data that the user edited and/or and image data on which the user made a mark.

3. The recording apparatus of claim 1, wherein the link information comprises:
user thumbnail index information indicating a recording location for the user thumbnail; and
user thumbnail index reference information that is designated in recording/reproducing information on the image data that the user worked on and identifies the user thumbnail index information.

4. The recording apparatus of claim 3, wherein the recording/reproducing information comprises:
program information, and/or playlist information, and/or mark information.

5. The recording apparatus of claim 1, wherein the recording unit records information relating to the user when reproducing information on the image data that the user worked on.

6. A reproducing apparatus comprising:
a reading unit that reads link information linking image data from a recording medium, the linked image data is image data that a user worked on and a thumbnail of a user that is formed with a representative image of the user who worked on for the image data; and
an output unit that outputs the image data that the user worked on and the user thumbnail according to the link information.

7. The reproducing apparatus of claim 6, wherein the image data worked on by the user comprises:
image data that the user recorded and/or image data that the user edited and/or image data that the user made a mark.

8. The reproducing apparatus of claim 6, wherein the link information comprises:
user thumbnail index information indicating a recording location for the user thumbnail; and
user thumbnail index reference information that is designated in recording/reproducing information on the image data for that the user worked on and identifies the user thumbnail index information.

9. The reproducing apparatus of claim 8, wherein the recording/reproducing information comprises:
program information and/or playlist information and/or mark information.

10. A method of recording on a recording medium, comprising:
generating a user thumbnail from a user representative image;
generating link information to link together image data that a user worked on and the user thumbnail of the user who worked on the image data; and
recording the link information and the user thumbnail on the recording medium.

11. The recording method of claim 10, wherein the image data worked on by the user comprises:
image data that the user recorded and/or image data that the user edited and/or image data on which the user made a mark.

12. The recording method of claim 10, wherein the link information comprises:
user thumbnail index information indicating a recording location for the user thumbnail; and
user thumbnail index reference information that is designated in recording/reproducing information on the image data that the user worked on and indicates the user thumbnail index information.

13. The recording method of claim 12, wherein the recording/reproducing information comprises:
program information and/or playlist information and/or mark information.

14. The recording method of claim 10, further comprising:
recording information relating to the user in reproducing information on image data that the user worked on.

15. A reproducing method of reproducing on a medium, comprising:
reading link information from the medium, the link information linking image data that a user worked on and a user thumbnail formed with a representative image of the user who worked on for the image data; and
outputting the image data and the user thumbnail according to the read link information.

16. The reproducing method of claim 15, wherein the image data worked on by the user comprises:
image data that the user recorded and/or image data that the user edited and/or image data that the user made a mark.

17. The reproducing method of claim 15, wherein the link information comprises:
user thumbnail index information indicating a recording location for the user thumbnail; and
user thumbnail index reference information that is designated in recording/reproducing information on the image data that the user worked on and indicates the user thumbnail index information.

18. The reproducing method of claim 17, wherein the recording/reproducing information comprises:
program information and/or playlist information and/or mark information.

19. A computer readable medium having embodied thereon a computer program to be read by at least one computer for a recording method comprising:
generating a user thumbnail from a user representative image; and
generating link information linking image data that a user worked on and the user thumbnail of the user who worked on the image data, and recording the link information and the user thumbnail on the computer readable medium.

20. A computer readable medium having embodied thereon a computer program to be read by at least one computer for a reproducing method, comprising:
reading link information from the computer readable medium, the link information linking image data that a user worked on and a user thumbnail formed with an image of the user who worked on the image data; and
outputting the image data and the user thumbnail according to the link information.

21. A method of storing information in a directory of a digital video recorder and/or reproducer system that records and/or reproduces thumbnail files, the method comprising:
storing a user thumbnail file corresponding to another thumbnail file having information, the user thumbnail file indicating a user that worked on the information of the corresponding thumbnail file,
wherein the user thumbnail file and the corresponding thumbnail file are linked together.

22. The method of storing information of claim 21, wherein the worked on information of the corresponding thumbnail file includes any changes made to the information by the user.

23. The method of storing information of claim 21, wherein the user thumbnail file is recorded in one of a plurality of locations in the directory according to characteristic information.

24. The method of storing information of claim 23, wherein when the characteristic information is volume information, the user thumbnail file is stored in a ‘.dvr’ file.

25. The method of storing information of claim 23, wherein when the characteristic information is mark information, the user thumbnail file corresponding with a mark thumbnail, which is an image indicating a mark point in order to view contents of a mark location, is stored in a ‘.rpls’ file, which includes a user thumbnail index that stores index numbers used to identify a user thumbnail of a user that made the mark.

26. The method of storing information of claim 25, wherein when the characteristic information is information relating to the mark point, the user thumbnail file corresponding with information relating to the mark point that is attached to a clip is stored in a ‘.clpi’ file, which includes a user thumbnail index that stores index numbers to identify the user thumbnail.

27. The method of storing information of claim 21, further comprising:
storing each user thumbnail image according to an identification number and size.
